(19) United States
(12) Patent Application Publication
(10) Pub. No.: US 2025/0172220 A1
(43) Pub. Date: May 29, 2025

(54) METHOD AND DEVICE FOR DETERMINING DATA ASSOCIATED WITH A PROCESS VALVE SHUT-OFF BODY

(71) Applicant: GEMÜ Gebr. Müller Apparatebau GmbH & Co. Kommanditgesellschaft, Ingelfingen (DE)

(72) Inventor: Thomas Volpp, Möckmühl (DE)

(21) Appl. No.: 18/834,336

(22) PCT Filed: Feb. 3, 2023
(86) PCT No.: PCT/EP2023/052680

§ 371 Date: Jul. 30, 2024

(30) Foreign Application Priority Data
Feb. 4, 2022 (DE) 10 2022 102 666.3

(51) Int. Cl. F16K 37/00; G05B 19/042

(52) U.S. Cl. CPC F16K 37/0041; G05B 19/042; G05B 2219/37559

(57) ABSTRACT

A method for operating a device for providing data associated with an exchangeable process valve shut-off body is provided. The device includes an illumination apparatus, an image sensor, a display unit, a data processing unit, and a communication interface. The illumination apparatus is configured to illuminate the process valve shut-off body arranged in a chamber. The image sensor is configured to generate a digital image of the process valve shut-off body arranged in the chamber and irradiated with light by the illumination apparatus. The display unit is configured to display the digital image. The data processing unit is configured to determine the data associated with the process valve shut-off body. The data includes the digital image. The communication interface, in particular a mobile radio interface, is configured to send the data associated with the process valve shut-off body.

The invention relates to a method and a device for determining data associated with a process valve shut-off body.

Process valve shut-off bodies are subject to wear. During the capturing of wear states of a process valve shut-off body, photographs are taken manually which-often in retrospect-do not have, with regard to the state of the surface of the shut-off body, the detail necessary for an assessment. This is due to different environmental parameters, such as light incidence and recording position. In particular, comparisons with other batches or test objects are therefore difficult or even impossible.

The problems addressed by the invention are solved by a method according to claim 1 and by a device according to an additional independent claim. Advantageous examples can be found in the dependent claims, the following description and the drawing.

One aspect of the description relates to the following subject matter: A method for operating a device for providing data associated with an exchangeable process valve shut-off body, in particular with a valve diaphragm, comprising: illuminating, by means of at least one illumination means, the process valve shut-off body arranged in a chamber; generating, by means of at least one image sensor, a digital image of the process valve shut-off body arranged in the chamber and irradiated with light by the illumination means; displaying, by means of at least one display unit, the digital image; determining, by means of at least one data processing unit, the data associated with the process valve shut-off body, wherein the data comprises the at least one digital image; and sending, by means of at least one communication interface, in particular by means of a mobile radio interface, the data associated with the process valve shut-off body.

Because of the arrangement of the process valve shut-off body in the chamber and the consistent recording conditions, digital images are generated which always have almost the same recording angle, the same resolution of the digital image, almost the same exposure conditions, almost the same orientation and the same color profile of the camera. Because of the arrangement of the process valve shut-off body in the chamber, the incidence of extraneous light is reduced. Due to this standardization of the recording conditions, the digital images of different process valve shut-off bodies are also easier to compare by machine. In particular, fault patterns across many process valve shut-off bodies can be better recognized.

Advantageously, an autonomous solution is provided that does not require any further setup by service personnel. This means that setup in the local company network is not required if a mobile radio interface is available. Furthermore, the device is set up only to capture process valve shut-off bodies and no further configuration steps are required.

Alternatively or additionally, the communication interface is designed as a WLAN interface (WLAN: Wireless Local Area Network).

In one example, the method comprises: determining, by means of at least one input unit, at least one manually input evaluation of a state of the process valve shut-off body and/or a property of the process valve shut-off body; wherein the data associated with the process valve shut-off body comprises the at least one digital image and the at least one evaluation and/or the property.

Advantageously, it is possible for the person who inserts the process valve shut-off body into the device to capture the subjective evaluation of the diaphragm and for the evaluation to be linked with the recorded image. Advantageously, on the one hand, documentation requirements can be fulfilled and, on the other hand, training data for training artificial models can be generated.

An advantageous example is characterized in that the method comprises: capturing, by means of at least one digital reading apparatus, an identifier which is associated with the process valve shut-off body and which is stored on a data carrier connected to the process valve shut-off body; wherein the data comprises the at least one evaluation, the digital image, and the identifier.

Advantageously, the capturing of the identifier of the process valve shut-off body enables tracking of the process valve shut-off body over its life cycle, i.e. from production, through active use, to disposal of the diaphragm.

In one example, the method comprises: displaying, by means of at least one display unit, the captured identifier associated with the process valve shut-off body; wherein the displayed identifier is concomitantly captured when the digital image of the shut-off body is generated.

This advantageously simplifies both the design of the device and the communication requirements of the device.

An advantageous example is characterized in that the method comprises: sending, by means of the at least one communication interface, the identifier; receiving, by means of the at least one communication interface, at least one piece of information associated with the process valve shut-off body in response to the sent identifier; and displaying, by means of the at least one display unit, the at least one piece of information associated with the process valve shut-off body.

Advantageously, centrally stored information associated with the particular process valve shut-off body can thus be retrieved and presented. This information includes at least one of the following: article number, article designation, customer order number, order confirmation, delivery note number, batch number, delivery date, serial number. As a result, this information is advantageously immediately available to the user and can be compared with other available information, for example with the information printed on the shut-off body or with delivery documents.

An advantageous example is characterized in that the method comprises: capturing, by means of the at least one input unit, at least one manually input property of the process valve shut-off body, the property being part of the data associated with the process valve shut-off body.

The property of the process valve shut-off body includes at least one of the following: name of the test order, material of the process valve shut-off body, test object number, type code, number of load cycles, process medium. In this way, tests can advantageously be documented easily and quickly. The shut-off body can then be reinstalled in the process valve for further load cycles in order to thereafter capture the state by means of the device again. This makes it quick and easy to capture reliable information regarding the service life of a specific diaphragm type.

An advantageous example is characterized in that the method comprises: receiving, by means of the at least one communication interface, a plurality of evaluation options for the process valve shut-off body, in particular according to the identifier associated with the process valve shut-off body; and wherein in particular the manually input evaluation of the state of the process valve shut-off body is a selection from among the received evaluation options.

As a result of this, for example type-specific and centrally stored evaluation options advantageously can be offered to the user. Centrally stored evaluation options can be advantageously adapted and refined if required.

An advantageous example is characterized in that the method comprises: determining, by means of the at least one data processing unit, at least one region within the at least one digital image which comprises potential damage; and displaying, by means of the at least one display unit, a marking of the at least one region within the digital image; and wherein the evaluation represents a subjective classification of damage to the process valve shut-off body in the at least one region.

Thus, possible damage is advantageously indicated to the user, and the user can subsequently evaluate or classify this possible damage. The user can remove the diaphragm from the chamber and examine the damage independently of the pictorial representation but with the help of the marked region in the displayed image. The probability that visually recognizable damage is not recognized is reduced. In this way, the quality of the damage examination of process valve shut-off bodies is improved overall.

An advantageous example is characterized in that the method comprises: sending, by means of the at least one communication interface, the at least one digital image and the at least one region; receiving, by means of the at least one communication interface, at least one suggestion for the classification of the damage to the process valve shut-off body which is associated with the region; and displaying, by means of the at least one display unit, the at least one suggestion.

Advantageously, a suggestion can be made by a remote central unit, in particular with the support of an artificial neural network, and displayed to the user for confirmation. Advantageously, this not only simplifies the classification of damage for the user, but also speeds it up. Furthermore, the centralized determination of the suggestion ensures that all damage to be classified can be determined on the basis of a common trained model. These centrally determined suggestions also mean that the trained specialists can better recognize damage and can classify it more independently.

In one example, the method comprises: comparing optical features of the shut-off body in the digital image with predefined target optical features; and displaying, by means of display unit, an indication to the user if said comparison shows deviations of the optical features from the target optical features; and generating the digital image again.

This advantageously gives the user the opportunity to correct machine recognition that is faulty by improving the arrangement of the diaphragm.

In one example, the method comprises: comparing brightness values of a plurality of spaced-apart brightness features in the digital image; and generating the digital image again with changed lighting of the shut-off body if said comparison indicates a brightness deviation.

Thus, uniform lighting of the entire scene is advantageously ensured, which benefits the entire data collection through better comparability of fault images.

In one example, the method comprises: tilting, by means of a tilting apparatus, the process valve shut-off body from a first position relative to the image sensor to a second position relative to the image sensor; and wherein the at least one digital image of the process valve shut-off body is recorded in the second position.

By this simple changing of the way the image sensor views the surface of the shut-off body, misinterpretations of reflections or mirroring can be reduced.

In one example, the method comprises: deforming, by means of a deformation apparatus, the process valve shut-off body from a relaxed state into a deformed state; and wherein the at least one digital image of the process valve shut-off body is recorded in the deformed state.

Thus, for example cracks which, without the deformation, would not be reproduced or would be only poorly reproduced in the digital image can be better recognized.

One aspect of the description relates to the following subject matter: A device for providing data associated with a process valve shut-off body, comprising at least one illumination means for illuminating the process valve shut-off body arranged in a chamber; at least one image sensor for generating at least one digital image of the process valve shut-off body arranged in the chamber and irradiated with light by the illumination means; at least one display unit for displaying the at least one digital image; at least one data processing unit for determining the data associated with the process valve shut-off body, wherein the data comprises: at least the at least one digital image; and at least one communication interface, in particular a mobile radio interface, for sending the data associated with the process valve shut-off body.

An advantageous example is characterized in that a holder, in particular a drawer that can be opened and can be moved into the chamber, the holder having a counter contour in which a contour of the process valve shut-off body can be arranged.

This advantageously ensures that the diaphragm is always arranged in the same way within the holder, which has an advantageous effect on the digital image of the process valve shut-off body.

An advantageous example is characterized in that the at least one illumination means emits diffuse light toward the process valve shut-off body.

In the drawing:

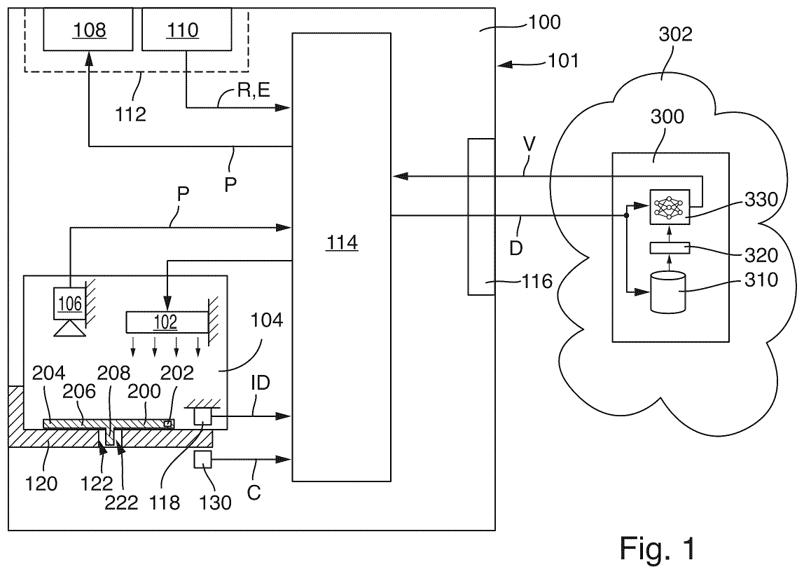

FIG. 1 shows a device for determining data associated with a process valve shut-off body;

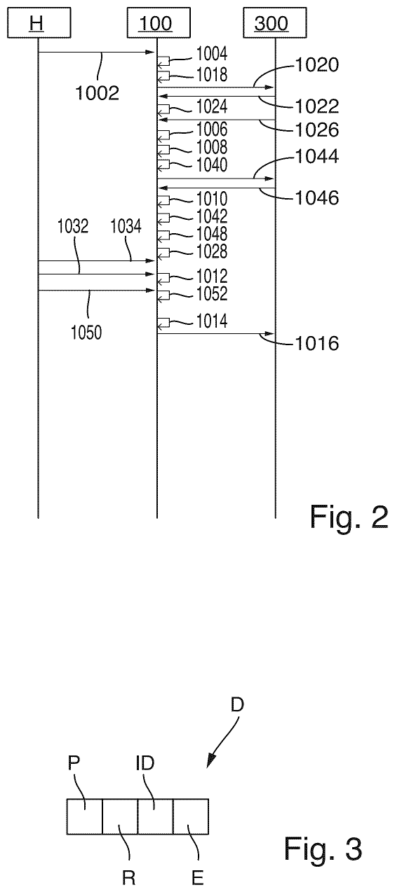

FIG. 2 shows a schematic sequence diagram;

FIG. 3 shows an exemplary structure of the data;

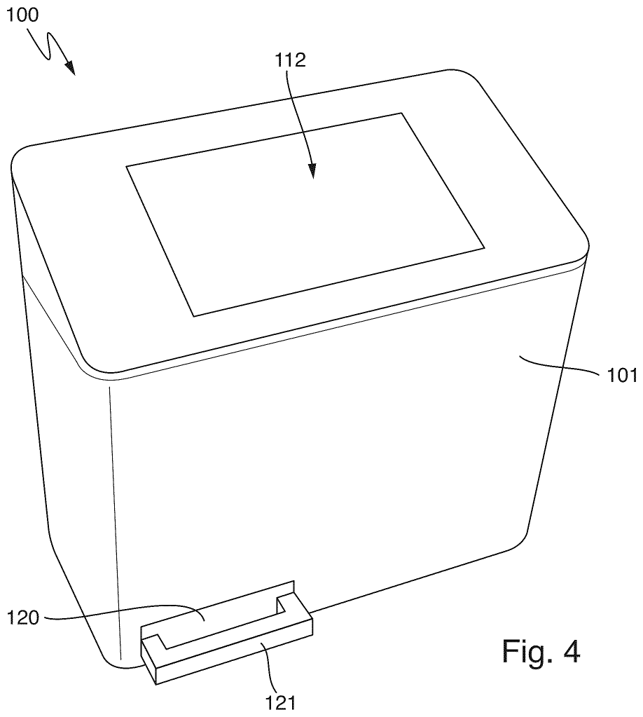

FIG. 4 shows the device in a perspective view;

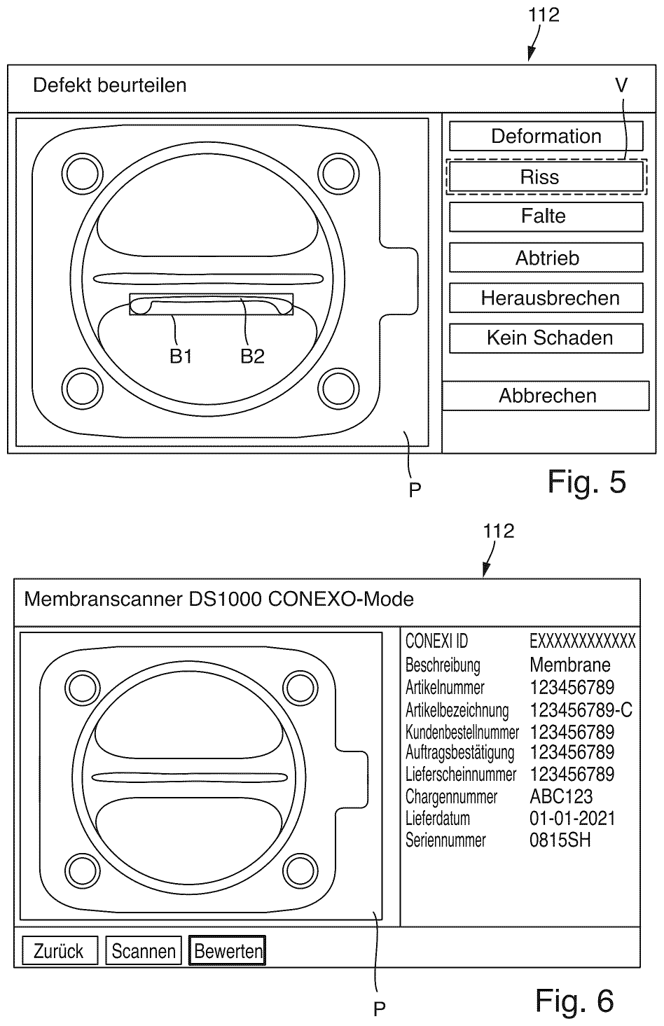

FIG. 5 shows screen contents for the evaluation of damage;

FIG. 6 shows screen contents for the displaying of information associated with the shut-off body;

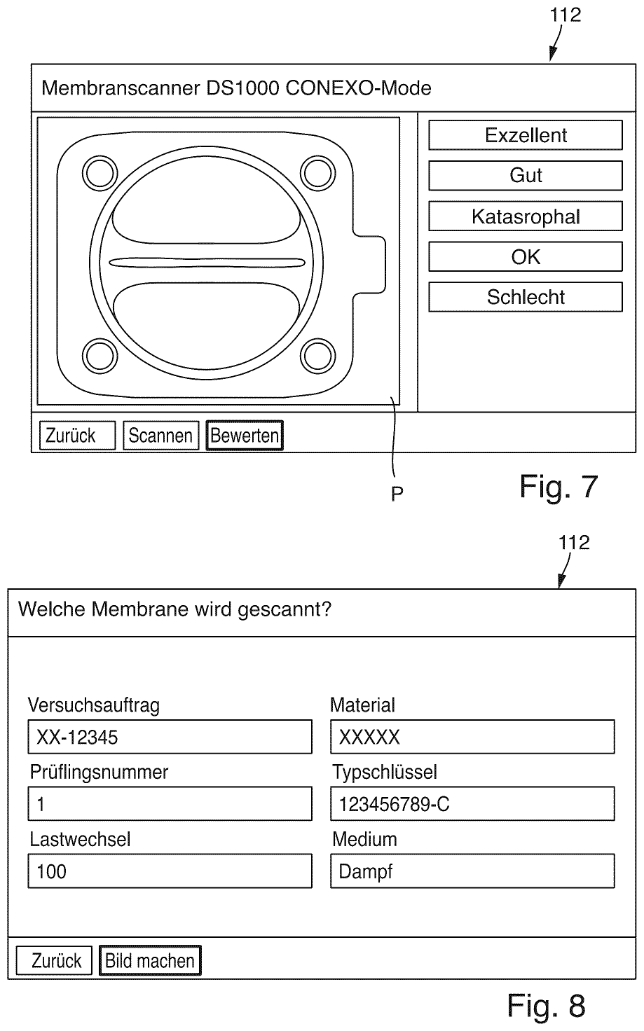

FIG. 7 shows screen contents for the evaluation of the state of the shut-off body;

FIG. 8 shows screen contents for the capturing of properties of the shut-off body;

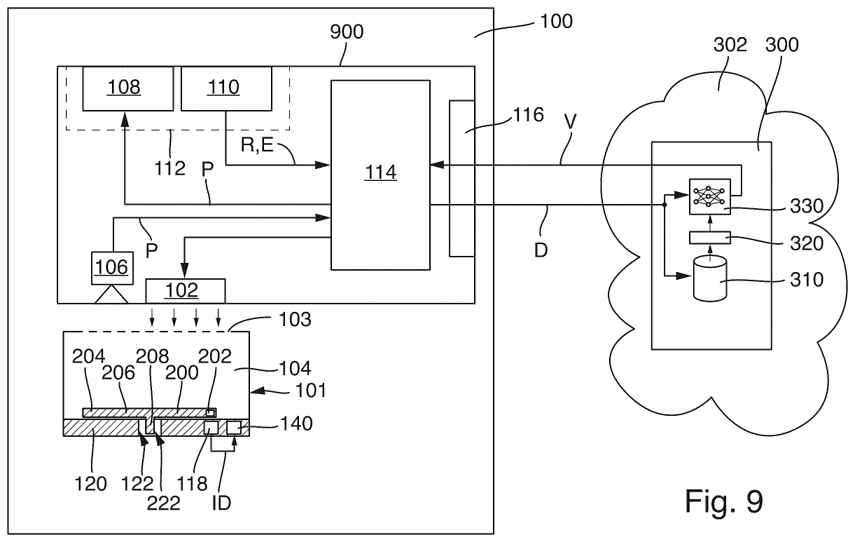

FIG. 9 shows an example of the device for determining the data associated with the process valve shut-off body;

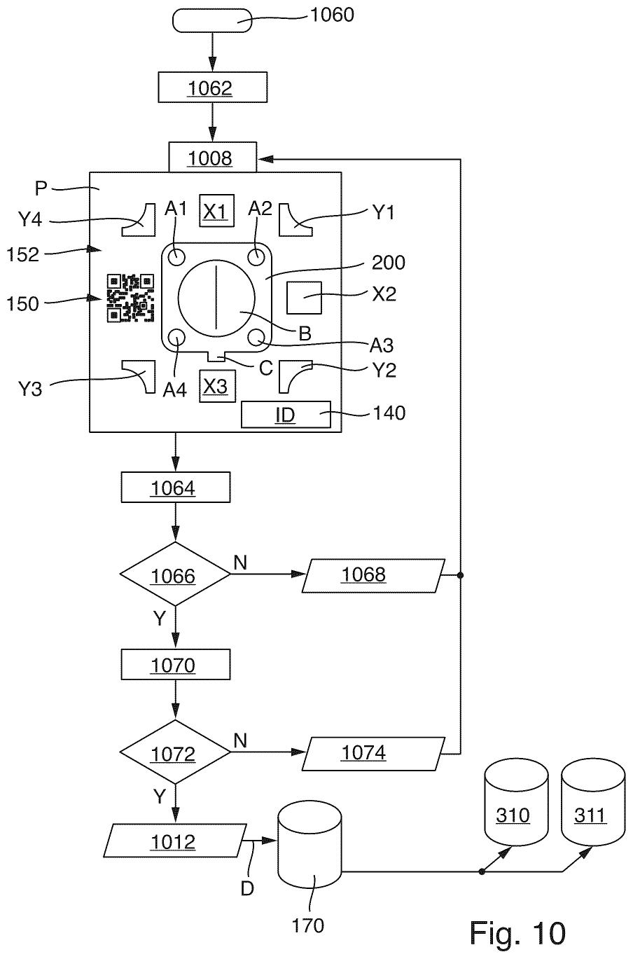

FIG. 10 shows a schematic sequence diagram;

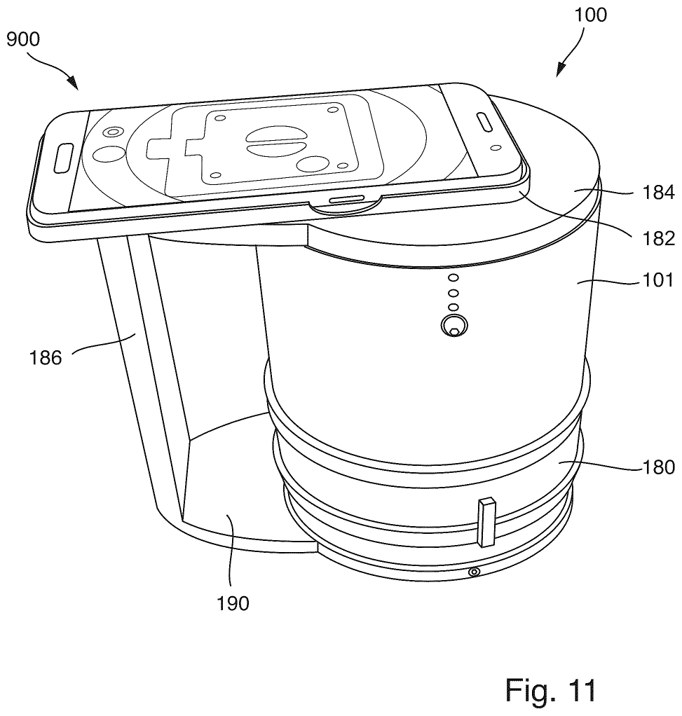

FIG. 11 shows an example of the device from FIG. 9 in perspective view;

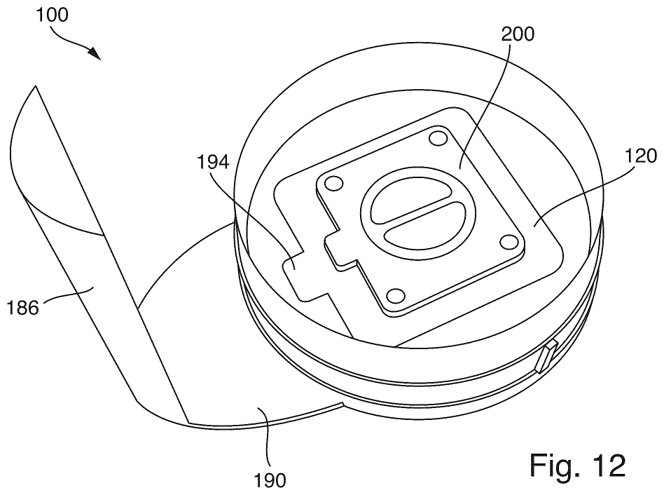

FIG. 12 shows the device from FIG. 11 in the open state;

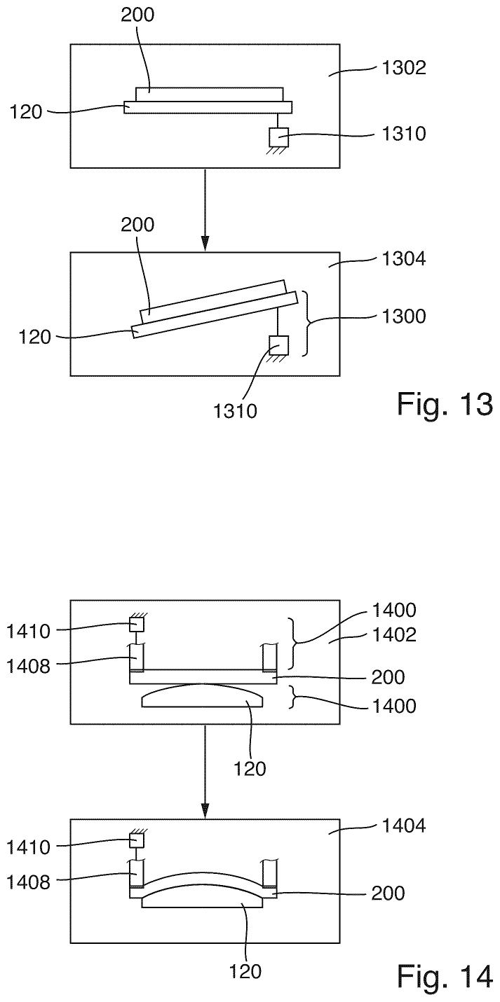

FIG. 13 shows a schematic sequence diagram for the tilting of the shut-off body; and

FIG. 14 shows a schematic sequence diagram for the deforming of the shut-off body.

A method for operating a device 100 for providing data D associated with an exchangeable process valve shut-off body 200 is explained below with reference to FIGS. 1, 2 and 3. The shut-off body 200 is a valve diaphragm in the following description, but in other examples it can also relate to another type of shut-off body, for example a plug diaphragm. Of course, the term “shut-off body” also includes control bodies which do not close the process valve completely, but rather control the flow through the process valve in a constantly open state.

In a step 1002, the user H arranges the process valve shut-off body 200 in a holder 120, for example a drawer. In the example of the drawer, the drawer is inserted into the device 100 with the shut-off body 200 arranged on the drawer. The holder 120, which is designed in particular as a drawer that can be opened and can be moved into the chamber 104, comprises a counter contour 122 in which a contour 222 of the process valve shut-off body 200 can be arranged.

For example, the process valve shut-off body 200 comprises a lateral clamping portion 204 and a movable functional portion 206 for controlling the process fluid in the process valve, said functional portion being arranged within the clamping portion 204. A central fastening pin 208 protruding from the shut-off body is part of the contour 222 which projects into the counter contour 122 of the holder 120 in the form of an opening.

In a step 1004, a sensor 130 arranged within the device 100 recognizes the closed position C of the chamber 104, in the example of the drawer on the basis of the closed sliding position of the drawer. After step 1004, the device 100 begins capturing the data D. In an alternative example, the capturing of the data D is started manually by the user. In an alternative example, the capturing is started as soon as the identifier of the shut-off body 200 has been successfully read.

In a step 1006, the process valve shut-off body 200 temporarily arranged in a chamber 104 is illuminated by means of an illumination means 102. In a step 1008, a digital image P of the process valve shut-off body 200 arranged in the chamber 104 and irradiated with light by the illumination means 102 is created by means of an image sensor 106. In a step 1010, the digital image P is displayed by means of a display unit 108.

The image sensor 106 may comprise a plurality of spaced-apart individual sensors. For example, the image sensor 106 can generate a 3D image or stereo image of the surface of the wet side of the shut-off body 200. The digital image P thus generated then comprises detailed information about the surface structures.

In a development, the illumination means 102 is designed such that it projects at least one pattern onto the surface of the shut-off body 200 for the generation, from different individual recordings, of the digital image P with increased details.

After the digital image P has been displayed, the user H evaluates the appearance of the shut-off body 200 in step 1032 and inputs their evaluation R via the input unit 110. Since the determination of the digital image P has already been completed, in a step 1034 the user H can optionally open the holder 120 and examine the shut-off body while holding it in their hand and with the aid of the displayed digital image.

In a step 1012, a manually input evaluation R of a state of the process valve shut-off body 200 is captured by means of an input unit 110. An integrated device 112, such as a touch panel, integrates the display unit 108 and the input unit 110. In a step 1014, the data D associated with the process valve shut-off body 200 is determined by means of a data processing unit 114, wherein the data D comprises the evaluation R and the digital image P. In a step 1016, the data D associated with the process valve shut-off body 200 is sent by means of a communication interface 116, in particular by means of a mobile radio interface. Alternatively or in addition to step 1016, the data D can also be stored locally in a storage medium.

The data D is received, for example, by a remote unit 300, which is operated, for example, by a cloud service provider 302. In a first example, the remote unit 300 comprises a data store 310 for storing the received data D.

In a second example, the remote unit 300 comprises a training unit 320 which trains a model 330 on the basis of the received labeled data D, i.e. comprising a respective evaluation R.

In a third example, the remote unit 300 comprises the trained model 330. When the data D is supplied, it is fed to an input layer of the trained model 330. Then the data is propagated through additional layers of the trained model 330. At an output layer of the trained model 330, a suggestion V for a classification of damage to the process valve shut-off body is output. The suggestion V is transmitted to the device 100, received by it and presented to the user H.

In a step 1018, an identifier ID which is associated with the process valve shut-off body 200 and which is stored on a data carrier 202 connected to the process valve shut-off body 200 is captured by means of a digital reading apparatus 118; the data D comprises the subjective evaluation R, the digital image B and the identifier ID.

In a step 1020, the identifier ID is sent by means of the communication interface 116. A piece of information associated with the process valve shut-off body 200 is received 1022 by means of the communication interface 116 in response to the sent identifier ID. In a step 1024, the piece of information associated with the process valve shut-off body 200 is output to the user H by means of the display unit 108.

In addition to the evaluation R, the user H can input a property E, which is part of the data D, via the input unit 110 in a step 1050. For this purpose, in a step 1052 a manually input property E of the process valve shut-off body 200 is captured by means of the input unit 110, the property E being part of the data D associated with the process valve shut-off body 200.

The illumination means 102 emits a diffuse light toward the process valve shut-off body 200. In one example, the illumination means 102 emits light from different directions onto the process valve shut-off body 200. In one example, the illumination means 102 radiates with different light spectra onto the process valve shut-off body for a plurality of digital images.

In an example not shown, a plurality of image sensors which generate digital images for the process valve shut-off body from different perspectives is provided.

In an example not shown, the position of the camera is changed to record digital images of the process valve shut-off body 200 from different perspectives.

In an example not shown, a device changes the position of the process valve shut-off body in the chamber so that digital images of the process valve shut-off body from different perspectives are generated.

In one example, the image sensor 106 is part of a ToF (time of flight) camera or part of a laser scanner, and the generated digital image comprises distance information.

In an example not shown, a device for overstretching the process valve shut-off body is provided. The shut-off body 200 is clamped between two points and the device 100 puts the shut-off body 200 under tension, and in this state the digital image is generated. This makes it possible to make cracks in the shut-off body 200 visible.

FIG. 4 shows the device 100 in a perspective view. The device 100 comprises a housing 101, within which the components are arranged. The holder 120 is translationally moved into the chamber 104 in the manner of a drawer. In the open state, the shut-off body 200 can be inserted into the holder 120. When the holder 120 is in the closed state, the chamber 104 is substantially shielded from outside light. A handle 121 is arranged on the outer face of the holder 120 for opening and closing.

Reference is made below to FIGS. 5 and 1 and 2. In a further example for improved evaluation of the state of the shut-off body 200, in a step 1026 a plurality of evaluation options for the process valve shut-off body 200 are received by means of the communication interface 116, in particular according to the identifier ID associated with the process valve shut-off body 200. These evaluation options are displayed to the user in a step 1028, by means of the display unit 108. These evaluation options can be seen, for example, on the right in FIG. 5. In particular, the manually input evaluation R of the state of the process valve shut-off body 200 is a selection made by the user from among the received evaluation options.

In a further example, in a step 1040 a region B1, B2 within the digital image P which comprises potential damage is determined by means of the data processing unit 114. During the determination 1040, the unprocessed original image from the image sensor is first used to identify there the valve diaphragm and its outlines in the image and to crop the image accordingly. The cropped image thus contains the valve diaphragm in a top view of the wet side. In the middle of the four white points, a circular part which comprises only the functional region of the valve diaphragm and which leaves out the clamping region is cut out. Within the functional region, damage is searched for using respective recognition functions.

For example, cracks in the diaphragm can be recognized on the basis of dark, connected regions and can be marked as the region B1, B2 in the digital image P. In a step 1042, a marking of the region B1, B2 within the digital image P is displayed by means of the display unit 108. The evaluation R represents a subjective classification of damage to the process valve shut-off body 200 in the region B1, B2 by the user. In one example, the evaluation options on the right are received from the unit 300.

In another example of the interaction between the device 100 and the remote unit 300, in a step 1044 the digital image P and the region B1 and/or B2 are sent to the unit 300 by means of the communication interface 116. The unit 300 determines, for example by means of a trained neural network, i.e. by means of a trained model, a suggestion V for the classification of the damage. The suggestion V for the classification of the damage to the process valve shut-off body 200 which is associated with the region B1, B2 is received by means of the communication interface 116 in a step 1046 and is displayed in step 1048, for example the evaluation option according to the suggestion V is visually visibly framed. The user can accept this suggestion or make a different evaluation. Thus, in one example the suggestion V is offered to the user for confirmation or rejection. In another example, from a list of classification options an entry according to the received suggestion is selected or preselected.

In the example of FIG. 5, an input of the property E of the shut-off body 200 is not required. This example therefore serves mainly to document a shut-off body that was removed from a process plant and subsequently disposed of.

In the screen presentation shown in FIG. 6, the digital image P is visible and on the right-hand side the data associated with the shut-off body which was received from the remote unit. The evaluation can be started by selecting the ‘Evaluate’ button.

In the screen presentation shown in FIG. 7, evaluation options which relate to the entire shut-off body are shown. A manual selection of the evaluation options represents the evaluation of the process valve shut-off body.

In the screen presentation shown in FIG. 8, properties of the shut-off body are captured. In the present example, tests with test objects are documented. To do this, the user first inputs the properties of the test object and can then create the digital image by selecting a button. In this case, the main concern is building a database that can also be used, for example, to train a model. If merely data without evaluation of the diaphragm state is to be created, an evaluation is not required and only the properties according to the screen presentation are captured. An evaluation can be added manually later.

FIG. 9 shows another example of the device 100 in a schematic block diagram. In contrast to FIG. 1, a mobile terminal 900 is part of the device 100. The mobile terminal 900 comprises at least the following components from FIG. 1: the data processing unit 114, the image sensor 106, the integrated device 112 comprising the input unit 110 and the display unit 108, and the communication interface 116. In addition, the illumination means 102 of the mobile terminal 900 can also be used in the device 100. In addition, reference is made to the statements regarding FIG. 1.

The mobile terminal 900 is, for example, a smartphone or a tablet having a WLAN interface and/or a cellular network interface in the sense of the communication interface 116.

The digital reading apparatus 118 reads the identifier ID from the data carrier 202 of the shut-off body 200 and forwards it to an additional display unit 140. The display unit 140 provides the identifier ID as a photographically capturable, pictorial representation. The identifier ID is then captured by the image sensor 106 and stored in the recorded digital image P together with the reproduction of the shut-off body 200.

Consequently, the method comprises displaying, by means of at least the display unit 140, the captured identifier ID associated with the process valve shut-off body 200, wherein the displayed identifier ID is concomitantly captured when the digital image P of the shut-off body 200 is generated.

The housing 101, which is separate from the terminal 900, comprises an opening 103 through which the image sensor 106 looks and through which the illumination means 104 radiates into the chamber and illuminates the shut-off body 200.

As an alternative to the shown assessment in the region of the device 300, which assessment was explained in more detail with reference to FIG. 1, the terminal 900 can independently carry out the assessment of the data D and of the digital image P.

Accordingly, a suggestion V for a classification of the damage to the process valve shut-off body 200 is determined by the data processing unit 114 of the terminal 900 and output to the user via the display unit 108.

FIG. 10 shows a schematic sequence diagram for the operation of the device 100 from one of the previous figures. After a start 1060, in an optional step 1062 the identifier ID of the shut-off body 200 is read from an RFID chip inserted into the shut-off body 200 and is captured as property E of the data D. Alternatively or additionally, an identifier of the process valve into which the shut-off body 200 was previously installed is captured as property E of the data D.

In step 1008, the digital image P of the illuminated shut-off body 200 is generated. The image P shown by way of example comprises additional image features, which are explained below. A device identifier 150 is visibly arranged on a surface 152 surrounding the shut-off body 200 and identifies, for example, the device 100 or the housing 101. The features Y1 to Y4 are used to check the brightness and are, for example, white. Color fields X1 to X3 are used for calibration and are, for example, colored differently from one another.

The shut-off body 200 itself has geometric features typical for the shut-off body. For example, the optical features A1 to A4 represent through-holes for stud bolts. The optical feature B represents a sealing edge introduced on the wet-side surface of the shut-off body 200, said sealing edge being provided for separation between the inner functional region and the clamping region surrounding the inner functional region. The optical feature C represents a tab which protrudes from the narrow side and into which an electronic data carrier bearing the identifier ID is inserted.

In the region of the surface 152, the display unit 140 displays the identifier ID previously read from the electronic data carrier.

The recorded digital image P thus contains optically recognizable features of the shut-off body 200 and, in addition, calibration features and identification features.

In a step 1064, the diaphragm position is checked on the basis of the geometric features. In addition, on the basis of the geometric features the diaphragm type can also be determined.

In one example of step 1064, the diaphragm type is determined using the identifier ID which can be read from the digital image P. The recognizable optical features in the image P, such as A1 to A4, B, C, are compared with previously determined and stored comparison features associated with the diaphragm type.

In step 1064, the device 100 can additionally be identified using the device identifier 150. On the basis of the device identifier 150, the measurement configuration can also be recognized. For example, it is possible to easily determine the scale of the digital image via the measurement configuration in order to determine, for example, distances resulting from geometric features.

If the comparison in step 1064 shows that the optical features recognized in the recorded digital image P do not match the stored optical features of the recognized diaphragm type, a switch is made from a comparison step 1066 to a step 1068. In step 1068, the user is notified that the comparison failed. Optionally, the user can be given additional indications, for example regarding incorrect positioning or regarding optical features of the diaphragm type which were not recognized. Proceeding from step 1068, a switch is made to step 1008 in order to start recording again. Alternatively, a diaphragm type can also be specified or confirmed manually.

If, however, the comparison in step 1064 shows that the optical features recognized in the recorded digital image P match the stored optical features of the diaphragm type, a switch is made to a step 1070.

The method comprises comparing 1064, 1066 optical features Al-A4, B, C of the shut-off body 200 in the digital image P with predefined target optical features associated with the diaphragm type; displaying 1068, by means of the display unit 1008, an indication to the user if said comparison shows deviations of the optical features A1-A4, B, C from the target optical features; and generating 1008 the digital image P again.

In step 1070, it is checked whether there is sufficient lighting of the shut-off body 200 in the image P or not. For example, on the basis of image values at the locations of the optical features Y1 to Y4, it is assessed whether the lighting prevailing at the time the image P was recorded, i.e. the illuminance, was sufficient and whether the illumination was sufficiently homogeneous.

If it is determined in a step 1072 that the illumination values are not sufficiently equal or are below a minimum threshold value, the user is informed in a step 1074 that the illumination is insufficient. Accordingly, the user can manually improve the illumination situation and generate another image P by repeating step 1008.

If it is determined in step 1072 that the lighting of the recording situation and of the shut-off body is sufficient, a switch is made to step 1012, in which the user can make comments or carry out the evaluation R of the state of the shut-off body 200.

Additionally or alternatively, in steps 1070 and 1072 the color fields X1 to X3 are used to recognize whether sufficient differentiation between the color values is possible. If the image quality is not sufficient, the user can be asked to record the image P again. Alternatively or additionally, the color fields X1 to X3 will be used to compensate for the camera-specific differences in color representation.

The method thus comprises comparing 1070, 1072 brightness values of a plurality of spaced-apart brightness features Y1-Y4 in the digital image; and generating 1008 the digital image P again with changed lighting of the shut-off body 200 if said comparison indicates a brightness deviation or inhomogeneous lighting. The brightness deviation may comprise an absolute comparison with a minimum threshold value and may comprise a relative comparison of the determined brightness values of the image P with each other.

If the image quality is sufficiently good, a switch is made to step 1012, in which the user can make the evaluation R of the state of the shut-off body 200. In addition, in step 1012 the user can input, for example, an identifier for the maintenance, so that a clear assignment to a specific maintenance interval is possible afterwards. The user can also enter their name or identifier here. Furthermore, a technical location where the recording was carried out can be input. The aforementioned data is then stored as property E of the data D.

After completion of step 1012, the data D is at least temporarily stored in a storage unit 170 of the device 100 in order to subsequently be stored in at least one storage unit 310, 311 of a remote unit 300. The storage units 310 and 311 are, for example, different databases that are used either to document the maintenance of a process plant or, for example, to collect training data for machine-trainable functions. From one of the storage units 310 and 311, it is then possible to generate, for example according to a predefined creation scheme, a maintenance report directed at specific maintenance of a process plant or of a part of the process plant, for documentation purposes.

The surface 152 is part of the holder 120 onto which the diaphragm or the shut-off body 200 is laid. The holder 120 is designed, for example, to be exchangeable so that several sizes and different types of shut-off bodies can be captured by means of one device or by means of one housing. The orientation of the holder 120 is clear and mistake-proof, for example due to a corresponding coding and a corresponding form-locking connection, so that the image sensor and the holder 120 are always in an expected position relative to one another.

As an alternative to the user-triggered recording of the digital image P in step 1008, this can also be done independently by the device 100. For example, the illumination of the scene in the chamber can be automatically adjusted and changed in order to achieve optimal lighting and to perform the feature recognition. Then, for example, one of the indications to the user from steps 1068 and 1074 is not required and the device 100 independently determines the digital image P in order to offer it to the user for evaluation in step 1012.

FIG. 11 shows a perspective view of an example of the device 100 comprising the terminal 900 and the housing 101. The chamber into which the camera or the image sensor of the mobile terminal 900 looks is located within the housing 101. The closed chamber within the housing 101 makes it possible to define standardized lighting scenarios. Likewise, the illumination unit or the illumination means of the mobile terminal 900 is directed into the chamber and illuminates the shut-off body arranged there.

A light-transparent portion 180 of the housing 101 allows light from outside to enter the chamber and to result in more uniform illumination of the scene within the chamber.

An exchangeable holder 182 for terminals 900 is arranged between the terminal 900 and the housing 101. The holder 182 is specially adapted to the model of the terminal 900 used, and the holder 182 comprises in particular the openings for the camera sensor and the illumination means of the terminal 900.

The housing 101 is closed with a cover 184. The cover 184 or the holder 182 comprises a lens hood. This avoids a glare effect.

As an alternative to the exchangeable static holder 182, sliders are provided on the cover 184, which form a holding space for the terminal 900 that can be adapted to the type of the terminal 900. An aperture with variable cross section is provided on the cover 184. Thus, different types of terminals 900 can be arranged on the housing 101.

In another example, the cover 184 or the holder 182 comprises a light guide into which the light from the illumination means of the terminal 900 is coupled and from which the incoupled light is coupled out into the chamber with a scattering effect.

The holder 182 for the terminal 900 projects beyond a main body of the housing 101 and is supported by a support strut 186 which is connected to a base plate 190.

FIG. 12 shows the device 100 from FIG. 11 in an open state. The holder 120 is used to arrange the removed shut-off body 200. A stylized tab 194 of the holder 120 indicates the correct arrangement of the shut-off body 200 with its tab in the same orientation as the stylized tab. After the shut-off body 200 has been inserted, the housing 101 of the device 100 is closed and the digital image can be generated.

FIG. 13 shows a schematic sequence diagram. In a step 1302, the shut-off body 200 is located on the holder 120. A drive 1310 leaves the holder 120 in a normal position.

Starting from step 1302, the drive 1310 is operated to tilt the holder 120, for example about a tilt axis (not shown) that is perpendicular to the drawing plane. Accordingly, the drive 1310 moves the holder 120 with the shut-off body 200 arranged thereon into a tilted position in which the image sensor views a surface of the shut-off body 200, said surface being tilted relative to the normal position.

The method comprises tilting 1304, by means of a tilting apparatus 1300 consisting of the drive 1302 and the holder 120, the process valve shut-off body 200 from a first position relative to the image sensor 106 to a second position relative to the image sensor 106, wherein the at least one digital image P of the process valve shut-off body 200 is recorded in the second position.

FIG. 14 shows a schematic sequence diagram. In a step 1402, the shut-off body 200 is on the holder in a relaxed position. The shut-off body 200 therefore has an internal stress that keeps it in the shape shown in step 1402. A drive 1410 leaves the shut-off body 200 in this relaxed position. The holder 120 provides a counter contour directed toward the shut-off body 200.

Starting from step 1402, the drive 1410 applies a force to a pressure contour 1408, which presses annularly or, alternatively, in a punctiform manner on a part of the shut-off body 200 and transfers it into a stressed state. In the example, the shut-off body 200 is laid against the convex counter contour of the holder 120. The wet side of the shut-off body 200 is directed toward the camera and is convexly curved. Thus, for example, cracks or other signs of wear can be optically more evident on the convexly stressed wet side. Accordingly, in the stressed state the at least one digital image P is generated.

Alternatively, the shut-off body 200, which is clamped at at least two points, can also be put under compression or tension in order to better show cracks or other artifacts in the digital image P.

The method thus comprises deforming 1404 the process valve shut-off body 200 from a relaxed state into a deformed state by means of a deformation apparatus 1400, for example comprising the drive 1410, the pressure contour 1408 and the holder 120 with counter contour, wherein the at least one digital image P of the process valve shut-off body 200 is recorded in the deformed state.

1-18. (canceled)

19. A method for operating a device for providing data associated with an exchangeable process valve shut-off body, in particular with a valve diaphragm, the method comprising:
illuminating, by at least one illumination apparatus, the process valve shut-off body arranged in a chamber;
generating, by at least one image sensor, at least one digital image of the process valve shut-off body arranged in the chamber and irradiated with light by the illumination apparatus;
displaying, by at least one display unit, the at least one digital image;
determining, by at least one data processing unit, the data associated with the process valve shut-off body, wherein the data comprises the at least one digital image; and
sending, by at least one communication interface, in particular by a mobile radio interface, the data associated with the process valve shut-off body.

20. The method according to claim 19, further comprising:
determining, by at least one input unit, at least one manually input evaluation of a state of the process valve shut-off body and/or a property of the process valve shut-off body;
wherein the data associated with the process valve shut-off body comprises the at least one digital image and the at least one evaluation and/or the property.

21. The method according to claim 19, further comprising:
capturing, by at least one digital reading apparatus, an identifier which is associated with the process valve shut-off body and which is stored on a data carrier connected to the process valve shut-off body;
wherein the data comprises the at least one evaluation, the digital image, and the identifier.

22. The method according to claim 21, further comprising:
displaying, by at least one display unit, the captured identifier associated with the process valve shut-off body;
wherein the displayed identifier is concomitantly captured when the digital image of the shut-off body is generated.

23. The method according to claim 19, further comprising:
sending, by the at least one communication interface, the identifier;
receiving, by the at least one communication interface, at least one piece of information associated with the process valve shut-off body in response to the sent identifier; and
displaying, by the at least one display unit, the at least one piece of information associated with the process valve shut-off body.

24. The method according to claim 19, further comprising:
receiving, by the at least one communication interface, a plurality of evaluation options for the process valve shut-off body, in particular according to the identifier associated with the process valve shut-off body; and
displaying, by the at least one display unit, the received evaluation options;
wherein in particular the manually input evaluation of the state of the process valve shut-off body is a selection from among the received evaluation options.

25. The method according to claim 19, further comprising:
determining, by the at least one data processing unit, at least one region within the at least one digital image which comprises potential damage; and
displaying, by the at least one display unit, a marking of the at least one region within the digital image; and
wherein the evaluation represents a subjective classification of damage to the process valve shut-off body in the at least one region.

26. The method according to claim 25, further comprising:
sending, by the at least one communication interface, the at least one digital image and the at least one region;
receiving, by the at least one communication interface, at least one suggestion for the classification of the damage to the process valve shut-off body which is associated with the region; and
displaying, by the at least one display unit, the at least one suggestion.

27. The method according to claim 19, further comprising:
comparing optical features of the shut-off body in the digital image with predefined target optical features; and
displaying, by display unit, an indication to the user if the comparison shows deviations of the optical features from the target optical features; and
generating the digital image again.

28. The method according to claim 19, further comprising:
comparing brightness values of a plurality of spaced-apart brightness features in the digital image; and
generating the digital image again with changed lighting of the shut-off body if the comparison indicates a brightness deviation.

29. The method according to claim 19, further comprising:
tilting, by a tilting apparatus, the process valve shut-off body from a first position relative to the image sensor to a second position relative to the image sensor; and
wherein the at least one digital image of the process valve shut-off body is recorded in the second position.

30. The method according to claim 19, further comprising:
deforming the process valve shut-off body from a relaxed state into a deformed state by a deformation apparatus; and
wherein the at least one digital image of the process valve shut-off body is recorded in the deformed state.

31. A device for providing data associated with a process valve shut-off body, the device comprising:
at least one illumination apparatus configured to illuminate the process valve shut-off body arranged in a chamber;
at least one image sensor configured to generate at least one digital image of the process valve shut-off body arranged in the chamber and irradiated with light by the illumination apparatus;
at least one display unit configured to display the at least one digital image;
at least one data processing unit configured to determine the data associated with the process valve shut-off body, wherein the data comprises the at least one digital image;
and at least one communication interface, in particular a mobile radio interface, configured to send the data associated with the process valve shut-off body.

32. The device according to claim 31, further comprising:
at least one input unit configured to determine at least one manually input evaluation of a state of the process valve shut-off body and/or a property of the process valve shut-off body;
wherein the data associated with the process valve shut-off body comprises the at least one digital image and the at least one evaluation and/or the property.

33. The device according to claim 31, further comprising:
a holder, in particular a drawer that can be opened and can be moved into the chamber, the holder having a counter contour in which a contour of the process valve shut-off body can be arranged.

34. The device according to 31, wherein the at least one illumination apparatus emits diffuse light toward the process valve shut-off body.
